(19) United States
(12) Patent Application Publication
(10) Pub. No.: US 2009/0214387 A1
(43) Pub. Date: Aug. 27, 2009

(54) Assembly for Accommodating a Probe

(75) Inventors: Hermann Straub, Rottenburg (DE); Thomas Steckenreiter, Frankfurt (DE); Achim Rauch, Langweiler (DE)

Correspondence Address: BACON & THOMAS, PLLC, 625 SLATERS LANE, FOURTH FLOOR, ALEXANDRIA, VA, 22314-1176, US

(73) Assignee: ENDRESS + HAUSER CONDUCTA GESELLSCHAFT FUR MESS- U, Gerlingen (DE)

(21) Appl. No.: 12/083,921

(22) PCT Filed: Oct. 26, 2006
(86) PCT No.: PCT/EP2006/067810

§ 371 Date: Mar. 16, 2009

(30) Foreign Application Priority Data
Oct. 26, 2005 (DE) 10 2005 051 279.8

(51) Int. Cl. G01N 27/00

(52) U.S. Cl. 422/82.01

(57) ABSTRACT

The invention relates to an assembly for accommodating a probe, especially a measuring probe or a sample-taking probe. The assembly includes a housing, which has a space for accommodating the probe and a first chamber for accommodating a first fluid, with the first chamber being in connection with the space for accommodating the probe or surrounding such. The housing further includes a connecting section, by means of which the housing is connectable with a container or is connected therewith. The container serves for accommodating a medium, a property of which is to be measured with the probe or from which a sample is to be taken. At least a second chamber is provided in the housing for accommodating a second fluid and is arranged between the first chamber and the connecting section of the housing.

The invention relates to an assembly for accommodating a probe, especially a measuring probe or a sample-taking probe. The assembly includes a housing having a space for accommodating the probe and a first chamber for accommodating a first fluid. The chamber is connected with the space for accommodating the probe or surrounds such space. The housing includes a connecting section, by a means of which the housing is connectable, or connected, with a container serving for reception of a medium, a property of which is to be measured with the probe or from which a sample is to be taken. The probe has an, especially, essentially cylindrical, elongated shaft, which is displaceable in the axial direction with reference to the housing.

The realm of applications of probes for sample-taking or for measuring properties of a medium is very large. For example, the manufacture of sterile solutions as regards pharmaceutical and medicinal products for peritoneal- and hemo-dialysis applications, or also the manufacture of perfusion solutions for rinsing organs or rinsing solutions for blood adsorbers, requires, among other things, the application of pH measuring probes for monitoring product, or for monitoring the manufacturing process. From the state of the art, it is known to perform an inline pH measuring of products, e.g. solutions, where so-called retractable assemblies having axially displaceable probe or receiving apparatus for a pH sensor are used. These retractable assemblies, lock assemblies or measured value transducer apparatuses include a rinsing chamber, into which the probe or a sensor can be moved intermittently during operation for calibration purposes, there to be brought into contact with a calibration liquid. When the calibration procedure is finished, the probe or its sensor can be rinsed and/or sterilized and then moved back into the product, in order to measure the pH value there.

In such case, a contamination of the solution, whose pH value is to be measured, with an calibration liquid, or, vice versa, a contamination of the calibration liquid by the solution, is blocked with the help of seals between rinsing chamber and product.

DE 100 54 272 A1 discloses, for example, a retractable assembly, which includes a housing having a sensor-equipped probe arranged displaceably therein. As needed, the probe can be withdrawn from the process, or measured medium, into the assembly housing and there treated in the required manner in a cleaning- or calibration-chamber sealed on the media-side from the medium. The media side is separated from the rinsing chamber by means of a separating element in the form of a ball valve. The separating of the rinsing chamber of a retractable assembly from the medium by means of seals placed in annular grooves is known, for example, from WO 2004/024353, WO 2004/023127, DE 198 43 553 A1 and DE 197 23 681 A1. From DE 100 24 564 A1, a probe system is known, whose rinsing chamber embodied as a calibration-chamber is sealed against the medium to be measured by means of a rotary disk means.

The use of such retractable assemblies in connection with sterile solutions is problematic, since, on the one hand, the long sterilization cycles of pH probes negatively affects the measured values of the pH probe in the product region (container), such that such measurements are unreliable. On the other hand, calibration liquids and other foreign materials must certainly not get into the product, since patient safety would be compromised thereby. In the case of failure of seals, consequently, an impermissible contamination of the product with calibration liquid (buffer solution) would take place, and this contamination might, additionally, remain unnoticed. Conversely, also a contamination of the calibration liquid by the product is conceivable. Therefore, in the case of use of such a measuring system, the pertinent GMP (good manufacturing practice) criteria would not be fulfilled. Thus, monitoring of pH value in the manufacture of sterile solutions is still done using manual sample taking and, subsequent, spatially separated analysis in the laboratory using applicable laboratory methods. Besides the complexity connected therewith, a further disadvantage of this manner of proceeding is that, already in the sample taking, a possible out-gassing of CO₂ from the solution can take place, which, in turn, would lead to a corresponding corruption of the measurement result.

Thus, it is evident that there is an unsatisfactory protecting of the product space against contamination by ancillary media used in retractable assemblies. Leakages are also not noticed, because the products are located, as a rule, in large reactors having many measuring points, which can scarcely be monitored visually, or also because highly automated processes with few personnel are involved.

An object of the present invention is, therefore, to develop an assembly of the above-stated type such that the probability of contamination of a first fluid located in a first chamber by the medium to be measured, or the probability of contamination of the medium to be measured by said first fluid, is reduced. Such object is achieved by an assembly having the features of claim 1.

Thus, it is provided that, in the housing, at least a second chamber is provided for accommodating a second fluid, the second chamber being arranged between the first chamber and the connecting section of the housing. As distinguished from assemblies known from the state of the art, thus, an additional chamber is provided, in which a second fluid can be accommodated, wherein the second chamber is arranged between the first chamber and the medium to be measured, or the connecting section of the housing. In the case of defective seals, both the probability for a contamination of the medium by the first fluid as well as also the probability for a contamination of the first fluid by the medium is reduced. Additionally, the assembly of the present invention enables a technical measurements monitoring of selected properties of the second fluid, which enables prompt recognition of damage to a seal.

The assembly of the invention overcomes the problem in a retractable assembly of insufficient compartmentalization of medium from product and vice versa, or insufficient protection of the first fluid against unnoticed leakages. In this way, the prerequisite for introduction of the desired inline pH measurements is provided.

Possible operational steps, i.e. process steps, for using the first and second chambers include, for example, rinsing, sterilizing, blow-out, pressure emptying, suction draw-off, covering with sealing medium, etc. Procedures are conceivable wherein the first and/or second fluid(s) are operated at positive as well as negative pressures. Understood as possible critical product features, or features of the medium, are, for example: Valuable, expensive, combustible, corrosive, poisonous, biohazardous, radioactive, etc. With the assembly of the invention, escape of such media from the container into the first chamber, as well as escape of fluid from the first chamber into the medium are effectively prevented, or promptly recognized, as the case may be.

It is also possible to recognize which seal is detective. Especially, also, a targeted stepping of pressure and temperature levels between the individual chambers and the container can be used. The purposeful setting of pressure and temperature levels between the individual chambers and the container is done, in such case, on the basis of the particular product and operating conditions.

The assembly of the invention has, additionally, the advantage that suitable sealing materials can be directly applied. The design of seals in assemblies known from the state of the art e.g. as regards material, chemical/thermal properties, compatibility, service lives and the like is done on the basis of product conditions and can represent a compromise. Seals known from the state of the art are contacted on the one side by the medium to be measured, and on the other side by the first fluid, which is located in the first chamber (rinsing chamber, calibration chamber). Since these two fluids can have very different characteristics, seal design is burdened with compromises. The seals applied in the state of the art are, in given circumstances, not optimum for contact with the medium to be measured and/or not optimum for contact with the first fluid.

The assembly of the invention removes this problem by the feature that the media-side sealing of the second chamber can be designed according to the conditions posed by the medium to be measured, while the sealing in the region of the first chamber can be designed according to the conditions given by the first fluid.

In this way, the advantage results that the maintenance intervals of the seals can be enlarged and the service life of the seals increased. Additionally, advantages result as regards reliability of the calibration process, due to avoidance of contaminations of the calibrating medium.

It is especially advantageous when the first chamber has an inlet and an outlet, by means of which the first fluid is introducible into the first chamber and removable from the first chamber. In a preferred embodiment of the invention, it is provided that flow is continuous through the first chamber. Fundamentally, however, the invention also includes the embodiment wherein the first chamber is flowed through or wherein a non-flowing fluid is present in the first chamber. The type of fluid is largely arbitrary. Possibilities include, for example, a rinse liquid or a calibration liquid, by means of which a probe and, or its sensor, is cleaned and or calibrated, as the case may be.

Also the second chamber can have an inlet and an outlet, by means of which the second fluid is introducible into the chamber and removable from the second chamber. Also, the second fluid is preferably conveyed continuously through the second chamber. Also here, however, a discontinuous manner of operation is conceivable, as well as also the case in which the second fluid is not flowing through the second chamber, but is, instead, standing in such.

In another embodiment of the invention, it is provided that the inlet and/or outlet of the second chamber are/is arranged in such a manner that they open in a region of the second chamber, which is facing the first chamber. If a leakage happens between first chamber and second chamber, especially such an arrangement of the outlet effects that the fluid entering from the first into the second chamber can be detected early, so that appropriate measures can be brought into play in sufficient time.

In a further embodiment, a first seal is provided, which seals the first chamber relative to the second chamber. Preferably, it is provided that, in such case, the seal is one that sealingly surrounds the inserted probe. The seal thus effects a sealing between the outside of the probe and the interior of the housing. If a leakage happens in the region of this seal, so that the first fluid flows from the first chamber into the second chamber, such can be detected by means of suitable measuring equipment.

In a further embodiment of the invention, a second seal is provided which seals the second chamber from the environment, especially from the interior of the container. Also this seal is preferably so embodied that it sealingly surrounds an inserted probe. The sealing is thus here also between the outside of the probe and the inside of the housing.

In a preferred embodiment of the invention, it is provided that the space of the housing in which the probe is accommodated is embodied in such a manner that the probe, when it is accommodated in the housing, extends through the first chamber and/or the second chamber. Conceivable, for example, is that the housing has an axial length which fits that of the probe and that the first and second chambers are arranged in the housing axially spaced from one another.

In a preferred embodiment of the invention, the housing is embodied with rotational symmetry and the first and second chambers are arranged coaxially in the housing.

In an especially preferred embodiment of the invention, a measuring apparatus is provided, by means of which at least one property of the fluid located in the second chamber or flowing out of the second chamber is measurable. Considered, for example, is the measuring of the conductivity of the second fluid, which then changes in this example of an embodiment, when the second fluid is mixed with the first fluid or with the medium located in a container due to a leakage. Fundamentally, also various other properties of the second fluid can be registered, such as, for example, temperature, color, absorption properties relative to light, etc.

The measuring apparatus can be located inside or outside of the second chamber. An option, for example, is to arrange a measuring apparatus within the second chamber for measuring a certain property of the second fluid changing upon entrance of the first fluid and/or of the medium to be measured into the second chamber. Included in the invention is likewise the case in which the measuring apparatus is arranged outside of the second chamber. An option, for example, is that the second fluid flows through the second chamber and a property of the medium flowing out of the second chamber is registered by means of the measuring apparatus.

In another embodiment of the invention, it is provided that the second chamber has an inlet and that a supply means, especially a pump, is provided, which is connected with the inlet of the second chamber and is embodied in such a manner that flow is continuous through the second chamber. Furthermore, it can be provided that the first chamber has an inlet and that a supply means, especially a pump, is provided, which is connected with the inlet of the first chamber and is embodied in such a manner that flow is continuous through the first chamber.

An option is that the mentioned pumps are connected on their inlet sides with different supply containments storing the corresponding liquids (rinse- and calibration-liquids). The rinse- and calibration-liquids can be sterile.

In another embodiment of the invention, it is provided that the assembly additionally includes a drive unit, by means of which the probe inserted into the housing can be moved between different positions. As is already known from the state of the art, the probe can be moved by means of such a drive unit between an operating position, in which a property of the medium is to be measured or in which a sample is to be taken, and another position in which the probe is rinsed or calibrated, or the sample is dispensed from the probe.

The type of drive is largely arbitrary. Options include, for example, that the drive unit includes a piston, which is accommodated in a cylinder for back and forth movement, with the cylinder having connections for compressed air or other medium under pressure.

Limit switches and/or proximity switches can be used to control stroke length.

The invention relates also to the assembly of the invention, in the housing of which a probe, especially a sample-taking probe or a pH-value measuring probe, is accommodated.

The probe can be arranged in the housing movably into different positions manually or by means of the drive unit. The different positions can include a first position, in which at least one region of the probe extends into a medium situated in a container, with which the assembly is connected, and a second position, in which at least one region of the probe is located in the first chamber. Such region of the probe can involve a sensor of the probe or a sample-taking means of the probe.

Additionally, it can be provided that a rinse- or calibration-solution or a sterilization fluid is accommodated in the first chamber or that a rinse- or calibration-solution or a sterilization fluid flows through the first chamber. Preferably, it is further provided that, accommodated in the second chamber is a fluid which is uncritical relative to the medium accommodated in the first chamber and relative to the medium accommodated in the container, or it is provided that such a fluid flows through the second chamber. A fluid is in this sense uncritical when it is biologically and/or chemically and/or physically neutral relative to the product and/or the liquid in the chamber. The second chamber can thus be flowed through by fluid sealing-medium or rinse medium, such as, for example, distilled water, neutral as regards the medium, a property of which is to be measured or from which a sample is to be taken, or such a medium can be present in the second chamber.

The term “probe” in the sense of the present invention is meant to include single- and multi-part components. Thus, for example, the probe may be composed of an immersion tube or some other holder, on which or in which a sensor or a sample-taking means is arranged. Also, the immersion tube or the probe may contain a cavity, in which the sensor is arranged. Likewise, the probe may be formed by the sensor.

The term “container” in the sense of the present invention is meant to include any unit, in which a medium can be accommodated or through which medium flows. Options include, for example, reactors, storage- or batch-containers, as well as lines, such as pipelines, or line sections.

The term “rinse” in the sense of the present invention is meant to include wash.

In a further development of the invention, the assembly of the invention can additionally include a third chamber, which connects to the first chamber on its side facing away from the second chamber. The third chamber serves especially for cleaning and disinfecting an axial section of the probe shaft located behind the first chamber during calibrating and during sterilizing of the probe, in order that germs are not transported, when this axial section of the probe shaft comes into the first chamber during shifting of the probe into the measuring position.

An embodiment in this connection is characterized in that the third chamber has an inlet and an outlet, by means of which a fluid can be introduced into the third chamber and removed from the third chamber.

Additionally, a third seal can be provided, which seals the first chamber relative to the third chamber, with the seal lying against the shaft of the probe, as well as a fourth seal, which seals the third chamber on its side facing away from the first chamber, with the seal lying against the shaft of the probe.

As before, the third seal and/or the fourth seal can be built of two sealing elements, preferably two O-ring seals, which are axially spaced from one another, with, additionally, rinse connections being provided, by means of which the space between the sealing elements can be rinsed and/or sterilized.

Moreover, a measuring apparatus can be provided, by means of which at least one property of the second fluid located in the third chamber or flowing out therefrom is measurable.

In a simpler embodiment, the third chamber serves only as a separator between the cylinder of a pneumatic drive and the first chamber. In this way, it is assured that no axial section of the probe shaft protruding into the cylinder during withdrawal of the probe can penetrate into the first chamber when the probe is moved forward.

Additionally, one or more of the first to fourth seals can be designed as pneumatically controllable seals for the assembly, thus seals which can be pumped up, in which case the seal can either seal under pressure and be open in the relaxed state, thus in the absence of pressure, or vice versa. The advantage of such a seal is that the seal can be relaxed and spaced from the probe shaft during sterilization of the probe shaft, so that no poorly- or non-cleanable gaps are present during cleaning.

Further details and advantages of the invention will now be explained in greater detail on the basis of an example of an embodiment presented in the drawing, the figures of which show as follows:

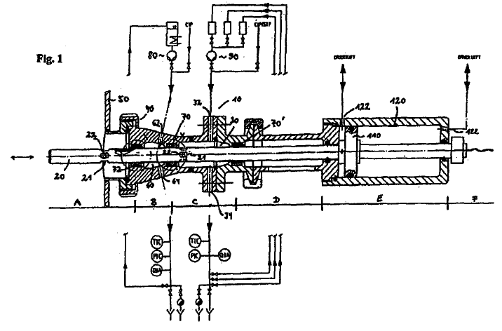

FIG. 1 a retractable assembly according to the present invention;

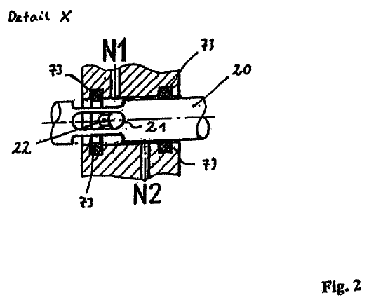

FIG. 2 a form of embodiment of detail “x” of FIG. 1; and

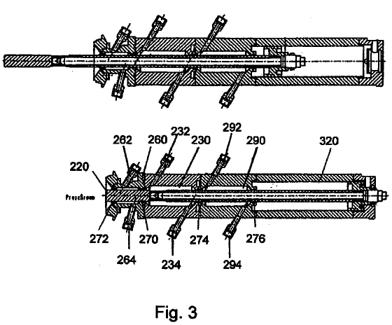

FIG. 3 a further embodiment of a retractable assembly of the present invention.

The drawing of FIG. 1 is subdivided into sections A-F, with the section A representing the reactor, or product space, in which the medium is present, a property of which is to be measured, or from which a sample is to be removed. Section B includes the so-called sealing-medium space, section C the so-called rinse-, change- and calibration-space, section D the so-called lantern, section E the drive and section F the breech, or closure, and sensor connection.

The retractable assembly includes the housing 10, in which the probe 20 is arranged axially displaceably for back and forth movement, such being indicated by the double arrow. Probe 20 can be, for example, a probe for sample taking or also a probe for measuring a certain value of the medium present in region A. Probe 20 is composed of a tube, in which openings 21 are provided, which allow access of the medium, or a rinse liquid, to a sensor 22 located within the tube of the probe 20.

Another option is that the probe can have cylindrical regions of stepwise changed diameter, so that, by axial movement of the probe, certain seals are purposely made accessible for rinsing and/or sterilizing.

Connected with probe 20 is piston 110, which is axially movable back and forth in the space established by the cylinder 120. Another option is that, by short back and forth movements of the probe during rinsing and/or sterilizing, the surfaces between the seals and the probe are made accessible for cleaning and/or sterilization. The cylinder has connections 122 for supply and removal of compressed air in the cylinder spaces separated by the piston 110, so that the desired movements of piston 110 and thus also probe 20 are possible.

The so-called lantern (region D) shown in FIG. 1 is provided with a length such that, in the case of axial movement of the probe, the regions of the probe passing through the piston 120 cannot come into contact with the seal 70′.

As indicated in the end region F on the right in the figure, probe 20 has a closure and/or sensor connection, there.

By means of the drive, probe 20 can be displaced between an operating position and a maintenance position.

In the position shown in the drawing, probe 20 is in its operating position, in which the openings 21 are located in the medium situated in region A, i.e. in the container 50.

Due to the openings 21, the medium is also in contact with the sensor 22, so that the desired property, for example pH-value, can be registered.

If it is desired to move probe 20 into its maintenance position, the leftmost compressed air connection 122 is supplied with compressed air, whereupon the piston 110 and thus also the probe 20 is moved to the right. When the maintenance position is reached, then the openings 21, as well as the probe 22 are located in the position indicated by dashed lines.

As also indicated by the figure, there is in the housing 10 a first chamber 30, through which the probe 20 passes. Chamber 30 has two axially spaced passageways, in which seals 70, 70′ are provided, which have the task of sealing the first chamber, in the case of inserted probe 20, relative to the neighboring chambers, or regions, of the housing 10. The first chamber 30 has an inlet 32 and an outlet 34. Inlet 32 is in communication with the pressure side of the pump 90, by means of which rinse liquid, calibration liquid or any other liquid may be caused to pass through chamber 30. On its suction side, pump 90 is connected with various storage containments, which individually or cumulatively can be connected with the pump inlet, in order to bring the desired medium through the first chamber 30.

FIG. 1 uses the abbreviations CIP (cleaning in place) and SIP (sterilization in place).

As indicated by FIG. 1, the liquid leaving the first chamber 30 via the outlet 34 is measured as regards its temperature, pressure and its properties, or, as the case may be, an appropriate control of these parameters is provided. Properties can be biological and/or chemical and/or physical properties.

As is further indicated in FIG. 1, the openings 21, as well as the sensor 22, are located inside chamber 30 in the maintenance position. If rinse- or calibration-liquid flows through the camber, then, correspondingly, a cleaning, or calibration, of the sensor 22 results.

The assembly of the invention has a connecting section 40, by means of which the assembly, or the housing 10, is connected with the container 50, in which the medium is located, whose property is to be measured. The container has an opening, in which a nozzle is welded. The nozzle has an external thread, which is engaged with a union nut in the connecting section 40 of the housing 10, so that the housing 10 is connected securely, but releasably, with the container 50. Through the opening of the container 50, probe 20 with its section containing the sensor 22 is introduced into the container 50, such being shown in FIG. 1.

Between this connection section 40 and the first chamber 30 is located the second chamber 60, through which the probe 20 also passes, as is evident from the figure. Chambers 30 and 60 are coaxially arranged and embodied spaced from one another in the axial direction of the housing 10, or probe 20. Also the second chamber 60 has an inlet 62 and an outlet 64, by means of which the second fluid is introduced into the second chamber 60 and also withdrawn therefrom. The second fluid, or sealing fluid, can be caused to move continuously or discontinuously by means of the pump 80, which is connected on the pressure side with the inlet 62 and on the suction side with a containment of sealing liquid. The second fluid is a liquid, which has an uncritical behavior relative to the medium located in the container 50 and relative to the fluid located in the first chamber, i.e. it is biologically and/or chemically and/or physically neutral relative to the product and/or to the liquid in the container 30. Preferably, the second chamber 60 is charged with WFI (water for injection) per pharmacopoeia.

The second chamber 60, as also the first chamber 30, has two axially spaced orifices, in which the already mentioned seal 70 as well as the seal 72 are arranged, which, in the presence of probe 20, effect a sealing of chamber 60 relative to the interior of the container 50 as well as also relative to the first chamber 30.

If a leakage occurs in the region of the seal 70, this leads to the fact that the first fluid from the first chamber 30 transfers into the second chamber 60, where it is mixed with the second fluid located there. This has the effect that a characteristic of the second fluid changes. This changing of a characteristic of the second fluid is registered by means of a measuring apparatus arranged outside of the housing 10 and standing in connection with the outlet 64 of the second chamber, i.e. the second fluid coming out of chamber 60 is reviewed as regards one or more characteristic properties.

Thus, as further indicated in FIG. 1, there is, in the region of the outlet line connected with the outlet 64, an apparatus for measuring temperature, pressure and properties of the second fluid. Such properties can be biological and/or chemical and/or physical characteristics.

The embodiment of the assembly according to the invention prevents that medium present in the region A can, in the event of a leakage, penetrate into the chamber 30 and corrupt the calibration process. Likewise, it is effectively prevented that calibration liquid enters from the chamber 30 into the medium present in region A, so that the present retractable assembly is especially suitable for the manufacture and/or monitoring of sterile solutions. Of course, also other areas of application then become feasible.

A leakage can, due to the measurement of a property of the second fluid leaving the second chamber 60, be promptly detected, so that appropriate measures can be directly engaged. An option is to apply the measured parameters immediately for process automation. An unknown, longstanding leakage leading to said contamination can, in this way, be excluded. Additional advantages include that the seals 70, 70′ and 72 can be designed corresponding to the properties of the contacting media, or fluids, and that fewer compromises as regards selection of the material of the seals need to be made.

In this way, longer service lives and longer maintenance intervals are obtained, coupled with simultaneously improved functional capability.

FIG. 2 shows a form of embodiment of the detail “x” of FIG. 1 and concerns, thus, the sealing between the region A and the second chamber 60 and between the second chamber 60 and the first chamber 30.

The respective seals located between these regions or chambers can, in a preferred embodiment of the invention according to FIG. 2, be constructed, in each case, of two mutually spaced O-ring seals 73. The space between these sealing rings 73 can, in this preferred form of embodiment of the invention, be rinsed and sterilized via rinse connections N1 and N2, analogously to the manner of proceeding in the case of a known rinsing chamber.

The retractable assembly shown in FIG. 3 concerns a further development of the invention having, process-side, or container-side, essentially the same construction as the example of an embodiment described above. In front of a first chamber 230, which serves especially for calibrating and sterilizing the probe, a second chamber 260 is placed on the side facing the process, in order to prevent media-dragging toward the process. The chambers have relative to one another, or relative to the process, seals 270, 272, and include connections for fluid supply and drain lines 232, 234, 262, 264, in order to charge the chambers with the required media.

Additionally, on the side of the first chamber 230 facing away from the second chamber 260, a third chamber 290 is provided, in order to be able to sterilize a back section of the shaft, which, in the retracted position of the probe 220, is located between the pneumatic drive unit in the third chamber. To this end, the chamber includes connections 292, 294 for supply and drain lines for the required media.

In summary, it is to be noted that the damage- and leakage-risk is minimized by the assembly of the invention, or is calculable. Maintenance effort, operating costs and personnel costs are minimized. Due to automatable and thus reproducible operating conditions, in the end, service life of the measuring probes increases.

As set forth above, the arrangement of the invention is not limited to the field of sterile solutions, but, instead, is universally applicable, preferably in the from of retractable assemblies, where, for any number of reasons, a contamination of product, or an auxiliary medium, must be prevented, or a seal damage detected, or an escape of the product out of the region A into the environment must be prevented.

An additional option is application in the form of a sample-taking apparatus.

Fields of application include, for example, pharmacy, chemistry, biotechnology, nuclear technology and other critical processes of working and processing technology. The assembly of the invention enables, especially, the application of extensive inline process analytics in the production process, e.g. NIR (near-infrared) and/or MIR (middle-infrared).

1-27. (canceled)

28. An assembly for accommodating a probe, especially a measuring probe or a sample-taking probe, comprising: a housing, which has a space for accommodating the probe;
a first chamber for accommodating a first fluid, said first chamber is connected with, or surrounds, said space for accommodating the probe;
said housing has a connecting section, by means of which said housing is connectable, or connected, with a container, with the container serving for accommodation of a medium, a property of which is to be measured with the probe or from which a sample is to be taken, wherein:
the probe has an, especially, essentially cylindrical, elongated shaft, which can be moved in the axial direction of the housing; and
in said housing, at least a second chamber is provided for accommodating a second fluid, said second chamber is arranged between said first chamber and said connecting section of said housing.

29. The assembly as claimed in claim 28, wherein:
said first chamber has an inlet and an outlet, by means of which the first fluid is introducible into said first chamber and removable from said first chamber.

30. The assembly as claimed in claim 28, wherein:
said second chamber has an inlet and an outlet, by means of which the second fluid is introducible into said second chamber and removable from said second chamber.

31. The assembly as claimed in claim 30, wherein:
said inlet and/or said outlet of said second chamber are arranged in such a manner that they open in a region in said second chamber facing said first chamber.

32. The assembly as claimed in claim 28, further comprising:
a first seal, which seals said first chamber relative to said second chamber, wherein:
said first seal contacts the shaft of the probe.

33. The assembly as claimed in claim 32, further comprising:
a second seal, which seals said second chamber relative to the environment, especially relative to the interior of said container, wherein:
said second seal contacts the shaft of the probe.

34. The assembly as claimed in claim 22, wherein:
said first seal and/or said second seal is constructed of two sealing elements, preferably two O-ring seals, which are axially separated, and rinse connections are provided, by means of which intermediate space between the sealing elements can be rinsed and/or sterilized.

35. The assembly as claimed in claim 28, wherein:
the space for accommodating the probe is embodied in such a manner that the probe, when accommodated in the housing, passes through said first chamber and/or said second chamber.

36. The assembly as claimed in claim 28, further comprising:
a measuring apparatus, by means of which at least one property of the fluid located in said second chamber or flowing therefrom is measurable.

37. The assembly as claimed in claim 36, wherein:
said measuring apparatus is arranged inside or outside of said second chamber.

38. The assembly as claimed in claim 28, further comprising:
supply means, especially a pump, wherein:
said second chamber has an inlet to which said supply means is connected and is embodied in such a manner that a continuous and/or discontinuous charging of said second chamber with fluid is accomplished.

39. The assembly as claimed in claim 28, further comprising:
supply means, especially a pump, wherein:
said first chamber has an inlet to which said supply means is connected and is embodied in such a manner that a continuous and/or discontinuous charging of said first chamber with fluid is accomplished.

40. The assembly as claimed in claim 28, further comprising:
a drive unit or is connected with a drive unit, by means of which the probe set in said housing is movable between different positions.

41. The assembly as claimed in claim 40, wherein:
said drive unit includes a piston, which is accommodated for movement back and forth in a cylinder, wherein the cylinder has connections for compressed air or other medium under pressure.

42. The assembly as claimed in claim 28, wherein:
accommodated in said housing, is the probe.

43. The assembly as claimed in claim 42, wherein:
the probe is movable in said housing into different positions manually or by means of said drive unit.

44. The assembly as claimed in claim 43, wherein:
the different positions include a first position, in which at least one region of the probe extends into the medium accommodated in said container, with which the assembly is connected, and a second position, in which at least one region of the probe is located in said first chamber.

45. The assembly as claimed in claim 44, wherein:
said at least one region of the probe is a sensor or a sample-taking means.

46. The assembly as claimed in claim 28, wherein:
a rinse- or calibration-solution is accommodated in said first chamber or a rinse- or calibration-solution flows through said first chamber.

47. The assembly as claimed in claim 28, wherein:
in the second chamber, a fluid is accommodated or flows, which is uncritical relative to the medium accommodated in said first chamber and relative to the medium accommodated in said container.

48. The assembly as claimed in claim 28, further comprising:
a third chamber, which adjoins said first chamber on a side thereof facing away from said second chamber.

49. The assembly as claimed in claim 48, wherein:
said third chamber has an inlet and an outlet, by means of which a fluid is introducible into said third chamber and removable from said third chamber.

50. The assembly as claimed in claim 48, further comprising:
a third seal which seals said first chamber relative to said third chamber, wherein:
said third seal contacts the shaft of the probe.

51. The assembly as claimed in claim 28, further comprising:
a fourth seal, which seals said third chamber on its side facing away from said first chamber, wherein:
said seal contacts the shaft of the probe.

52. The assembly as claimed in claim 48, wherein:
said third seal and/or said fourth seal is constructed of two sealing elements, preferably two O-ring seals, which are axially spaced from one another; and
additionally, rinse connections are provided, by means of which space between the sealing elements can be rinsed and/or sterilized.

53. The assembly as claimed in claim 28, further comprising:
a measuring apparatus, by means of which at least one property of the fluid located in said third chamber or flowing therefrom is measurable.

54. The assembly as claimed in claim 28, wherein:
one or more of said first to fourth seals of the assembly are designed as a pneumatically controllable seal or a seal which can be pumped up; and
the seal either seals under pressure and is open in the relaxed state, thus in the absence of pressure, or vice versa.
